(19) United States
(12) Patent Application Publication
(10) Pub. No.: US 2023/0321660 A1
(43) Pub. Date: Oct. 12, 2023

(54) REACTION VESSEL

(71) Applicant: Roche Diagnostics Operations, Inc., Indianapolis, IN (US)

(72) Inventors: Christoph Faigle, Muensing (DE); Thomas Heinemeyer, Bochum (DE); Florian Schweinberger, Muenchen (DE); Roland Thiele, Sindelsdorf (DE)

(73) Assignee: Roche Diagnostics Operations, Inc., Indianapolis, IN (US)

(21) Appl. No.: 18/335,608

(22) Filed: Jun. 15, 2023

Related U.S. Application Data
(63) Continuation of application No. PCT/EP2022/053576, filed on Feb. 15, 2022.

(30) Foreign Application Priority Data
Feb. 16, 2021 (EP) 21157406.6

(51) Int. Cl. B01L 3/00

(52) U.S. Cl. CPC B01L 3/5082; B01L 2300/023; B01L 2300/0663; B01L 2300/0832; B01L 2300/024

(57) ABSTRACT

A reaction vessel for a diagnostic analyzer comprising a plurality of processing stations. The reaction vessel comprises at least one sensor configured to measure at least one physical parameter associated with at least one of the processing stations of the diagnostic analyzer when disposed at the at least one of the processing stations, a memory configured to at least temporarily store at least one measurement value indicating the physical parameter provided by the sensor, a processing unit configured to control the sensor and to output measurement data including the measurement value from the memory, an interface configured to provide communication of the processing unit with an external electronic device, a power source configured to supply electric power to the sensor, the processing unit and the memory. The reaction vessel defines an internal volume. The sensor, the processing unit, the memory and the interface are arranged within the internal volume.

### CROSS-REFERENCE TO RELATED APPLICATIONS

This application is a continuation of International Application No. PCT/EP2022/053576, filed 15 Feb. 2022, which claims priority to European Application No. 21157406.6, filed 16 Feb. 2021, the disclosures of which are hereby incorporated by reference in their entirety.

### TECHNICAL FIELD

The present disclosure relates to a reaction vessel for a diagnostic analyzer using re-usable and/or disposable parts used in contact with samples.

### BACKGROUND

In vitro diagnostic testing has a major effect on clinical decisions, providing physicians with pivotal information. Particularly, there is great emphasis on providing quick and accurate test results in critical care settings. In vitro diagnostic testing is usually performed by diagnostic analyzers using instruments operable to execute one or more processing steps or workflow steps on one or more biological samples and/or one or more reagents, such as pre-analytical instruments, post-analytical instruments and also analytical instruments.

Diagnostic instruments or analyzers are configured to obtain a measurement value from a sample. A diagnostic analyzer is operable to determine via various chemical, biological, physical, optical or other technical procedures a parameter value of the sample or a component thereof. A diagnostic analyzer may be operable to measure said parameter of the sample or of at least one analyte and return the obtained measurement value. The list of possible analysis results returned by the analyzer comprises, without limitation, concentrations of the analyte in the sample, a digital (yes or no) result indicating the existence of the analyte in the sample (corresponding to a concentration above the detection level), optical parameters, DNA or RNA sequences, data obtained from mass spectrometry of proteins or metabolites and physical or chemical parameters of various types. A diagnostic analyzer may comprise units assisting with the pipetting, dosing, and mixing of samples and/or reagents.

The diagnostic analyzer may comprise a process and detection system whose workflow is optimized for certain types of analysis. Examples of such analyzers are clinical chemistry analyzers, coagulation chemistry analyzers, immunochemistry analyzers, urine analyzers, nucleic acid analyzers, used to detect the result of chemical or biological reactions or to monitor the progress of chemical or biological reactions.

Such automatic diagnostic analyzers allow to increase the number of analytical processes and obtainable measurements values. For this reason, such automatic diagnostic analyzers use several processing stations for processing several samples provided in reaction vessels at the same time. For example, 2 to 8 or even more different processing stations are present with such a diagnostic analyzer for preparing, processing, analyzing the respective samples.

Many processes during automated sample handling and sample preparation cannot be observed on a running, closed system. Sometimes, the software does not allow special functions to conduct only parts of an automated sample workflow. In other cases, the complex system architecture does not allow to observe the specific positions in the analytical unit. That makes specification testing, optimization and troubleshooting very cumbersome. Currently no tools are available to investigate the sample preparation processes from a sample point of view on such diagnostic analyzers. The influence on the patient sample can only be investigated indirect via (continuous) system monitoring or quality control sample outcomes. Further, currently large manual efforts with respect to mechanical adjustment of the components of processing stations and/or moving mechanical parts in diagnostic analyzers are necessary. Often, two field service engineers are necessary, one at a computer to control components and another to guide the mechanical part due to distance between the part and the computer interface.

### SUMMARY

Although the embodiments of the present disclosure are not limited to specific advantages or functionality, it is noted that in accordance with the present disclosure a reaction vessel is provided that facilitates the observation and/or adjustment process for a diagnostic analyzer and reduces the time and/or frequency required for troubleshooting.

In accordance with one embodiment of the present disclosure, a reaction vessel for a diagnostic analyzer is provided comprising a plurality of processing stations, wherein the reaction vessel comprises: at least one sensor configured to measure at least one physical parameter associated with at least one of the processing stations of the diagnostic analyzer, a memory configured to at least temporarily store at least one measurement value indicating the physical parameter measured by the sensor, a processing unit configured to control the sensor and to output measurement data including the measurement value from the memory, an interface configured to provide communication of the processing unit with an external electronic device, a power source configured to supply electric power to the sensor, the processing unit and the memory, wherein the reaction vessel defines an internal volume, wherein the sensor, the processing unit, the memory and the interface are arranged within the internal volume.

These and other features and advantages of the embodiments of the present disclosure will be more fully understood from the following detailed description taken together with the accompanying claims. It is noted that the scope of the claims is defined by the recitations therein and not by the specific discussions of features and advantages set forth in the present description.

### BRIEF DESCRIPTION OF THE DRAWINGS

The following detailed description of the embodiments of the present disclosure can be best understood when read in conjunction with the following drawings, where like structure is indicated with like reference numerals and in which:

FIG. 1 shows a reaction vessel in accordance with an embodiment of the present disclosure;

FIG. 2 shows a schematic illustration of a diagnostic analyzer in accordance with an embodiment of the present disclosure;

FIG. 3 shows a front view of electronic components of the reaction vessel in accordance with an embodiment of the present disclosure;

FIG. 4 shows a rear view of the electronic components of the reaction vessel in accordance with an embodiment of the present disclosure;

FIG. 5 shows a block diagram of the electronic components of the reaction vessel in accordance with an embodiment of the present disclosure;

FIG. 6 shows a front view of electronic components of a reaction vessel in accordance with an embodiment of the present disclosure;

FIG. 7 shows a schematic illustration of another diagnostic analyzer in accordance with an embodiment of the present disclosure;

FIG. 8 shows a flowchart of an example for detecting physical parameters at a diagnostic analyzer by means of the reaction vessel in accordance with an embodiment of the present; and

FIG. 9 shows a flowchart of an example for determining an orientation of a component of a diagnostic analyzer by means of the reaction vessel in accordance with an embodiment of the present disclosure.

Skilled artisans appreciate that elements in the figures are illustrated for simplicity and clarity and have not been drawn to scale. For example, dimensions of some of the elements in the figures may be exaggerated relative to other elements to help improve understanding of the embodiment(s) of the present disclosure.

### DETAILED DESCRIPTION

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e., a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “typically”, “more typically”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The disclosure may, as the skilled person will recognize, be performed by using alternative features. Similarly, features introduced by “in an embodiment of the disclosure” or similar expressions are intended to be optional features, without any restriction regarding alternative embodiments of the disclosure, without any restrictions regarding the scope of the disclosure and without any restriction regarding the possibility of combining the features introduced in such way with other optional or non-optional features of the disclosure.

Thus, an intelligent or smart reaction vessel equipped with one or more miniaturized sensors is suggested, which can be processed like a real patient sample vessel for checking the functionality of the respective processing stations of the diagnostic analyzer. Particularly, the provision of one or more sensors allows to measure at least one physical parameter associated with at least one of the processing stations of the diagnostic analyzer. With other words, the reaction vessel is handled like a “normal” sample vessel and detects the physical parameter at or in the respective processing station by means of the one or more sensors. The memory allows to at least temporarily store the measurement results as provided by the one or more sensors. The processing unit controls operation of the one or more sensors and outputs the measurement results as appropriate, e.g., after receiving a corresponding output request or command. The interface allows to processing unit to communication with an electronic device external to the reaction vessel. The power source supplies electric power to the electronic components of the reaction vessel such as the one or more sensors, the processing unit and the memory. Furthermore, all electronic components such as the one or more sensors, the processing unit and the memory are miniaturized so as to fit within the internal volume defined by the reaction vessel.

Generally, the reaction vessel provides a high applicability on different available diagnostic analyzer system types. Further, the reaction vessel provides lower cost of ownership by workflow improvements and thus higher instrument uptime. Still further, the reaction vessel provides cost reduction for the manufacturer by faster troubleshooting or lower frequency of service engineer visits at a customer. Still further, the reaction vessel provides a shorter time for service engineer visits by automation through faster root cause analysis. Further, different parties profit by resolving instrument malfunction faster and narrowing down error sources. Furthermore, the reaction vessel provides an option on remote service with further time saving potential.

The term “reaction vessel” as used herein is a broad term and is to be given its ordinary and customary meaning to a person of ordinary skill in the art and is not to be limited to a special or customized meaning. The term specifically may refer, without limitation, to a container defining a rather small volume configured to receive a small volume of a sample which is intended to be subject to a chemical and/or physical reaction by a diagnostic analyzer. The reaction takes place within the vessel.

The term “diagnostic analyzer” as used herein is a broad term and is to be given its ordinary and customary meaning to a person of ordinary skill in the art and is not to be limited to a special or customized meaning. The term specifically may refer, without limitation, to any apparatus or apparatus component operable to execute one or more processing steps/workflow steps on one or more biological samples. The term “processing step” thereby refers to physically executed processing steps such as centrifugation, aliquotation, sample analysis and the like. The term “analyzer” covers pre-analytical sample work-cells, post-analytical sample work-cells and also analytical work-cells. Non-limiting examples for diagnostic analyzers are clinical chemistry analyzers, coagulation chemistry analyzers, immunochemistry analyzers, urine analyzers, nucleic acid analyzers, used to detect the result of chemical or biological reactions or to monitor the progress of chemical or biological reactions.

The term “processing station” as used herein is a broad term and is to be given its ordinary and customary meaning to a person of ordinary skill in the art and is not to be limited to a special or customized meaning. The term specifically may refer, without limitation, to any station of a diagnostic analyzer where a processing step is physically executed such as centrifugation, aliquotation, sample analysis and the like. Thus, the processing stations include one or more stations selected from the group consisting of: centrifuge, mixer, pipettor, gripper, incubator, shaker, evaporator, vessel tray loader.

The term “memory” as used herein is a broad term and is to be given its ordinary and customary meaning to a person of ordinary skill in the art and is not to be limited to a special or customized meaning. The term specifically may refer, without limitation, to a device that is used to store information for immediate use in a computer or related computer hardware device. It typically refers to semiconductor memory, specifically metal-oxide-semiconductor (MOS) memory, where data is stored within MOS memory cells on a silicon integrated circuit chip. The term “memory” is synonymous with the term “primary storage”. Computer memory operates at a high speed, for example random-access memory (RAM), as a distinction from storage that provides slow-to-access information but offers higher capacities. If needed, contents of the computer memory can be transferred to secondary storage; a very common way of doing this is through a memory management technique called virtual memory. The term “memory”, meaning “primary storage” or “main memory”, is often associated with addressable semiconductor memory, i.e., integrated circuits consisting of silicon-based MOS transistors, used for example as primary storage but also other purposes in computers and other digital electronic devices. There are two main kinds of semiconductor memory, volatile and non-volatile. Examples of non-volatile memory are flash memory (used as secondary storage) and ROM, PROM, EPROM and EEPROM memory (used for storing firmware such as BIOS). Examples of volatile memory are primary storage, which is typically dynamic random-access memory (DRAM), and fast CPU cache memory, which is typically static random-access memory (SRAM) that is fast but energy-consuming, offering lower memory areal density than DRAM.

The term “processing unit” as used herein is a broad term and is to be given its ordinary and customary meaning to a person of ordinary skill in the art and is not to be limited to a special or customized meaning. The term specifically may refer, without limitation, to a digital circuit which performs operations on some external data source, usually memory or some other data stream. It typically takes the form of a microprocessor, which can be implemented on a single metal-oxide-semiconductor integrated circuit chip. The term is frequently used to refer to the central processing unit in a system. However, it can also refer to other co-processors. A central processing unit (CPU), also called a central processor, main processor or just processor, is the electronic circuitry within a computer that executes instructions that make up a computer program. The CPU performs basic arithmetic, logic, controlling, and input/output (I/O) operations specified by the instructions in the program. Traditionally, the term “CPU” refers to a processor, more specifically to its processing unit and control unit (CU), distinguishing these core elements of a computer from external components such as main memory and I/O circuitry. Most modern CPUs are microprocessors, where the CPU is contained on a single metal-oxide-semiconductor (MOS) integrated circuit (IC) chip. An IC that contains a CPU may also contain memory, peripheral interfaces, and other components of a computer; such integrated devices are variously called microcontrollers or systems on a chip (SoC). Some computers employ a multi-core processor, which is a single chip or “socket” containing two or more CPUs called “cores”.

The term “interface” as used herein is a broad term and is to be given its ordinary and customary meaning to a person of ordinary skill in the art and is not to be limited to a special or customized meaning. The term specifically may refer, without limitation, to a shared boundary across which two or more separate components of an electronic system such as a computer system exchange information. The exchange can be between software, computer hardware, peripheral devices, humans, and combinations of these. Some interfaces may allow hardware devices to both send and receive data through the interface, while others may only provide an interface to send data to a given system. Hardware interfaces exist in many of the components, such as the various buses, storage devices, other I/O devices, etc. A hardware interface is described by the mechanical, electrical and logical signals at the interface and the protocol for sequencing them (sometimes called signaling). A standard interface, such as SCSI, decouples the design and introduction of computing hardware, such as I/O devices, from the design and introduction of other components of a computing system, thereby allowing users and manufacturers great flexibility in the implementation of computing systems. Hardware interfaces can be parallel with several electrical connections carrying parts of the data simultaneously, or serial where data are sent one bit at a time.

The term “power source” as used herein is a broad term and is to be given its ordinary and customary meaning to a person of ordinary skill in the art and is not to be limited to a special or customized meaning. The term specifically may refer, without limitation, to a source of electric power. Electric power is electrical energy which is transferred by an electric circuit and which is usually produced by electric generators or batteries.

The term “internal volume” as used herein is a broad term and is to be given its ordinary and customary meaning to a person of ordinary skill in the art and is not to be limited to a special or customized meaning. The term specifically may refer, without limitation, to a three-dimensional space enclosed by a boundary of a constructional member such as by walls. The term may particularly refer to the space that a constructional member or its shape occupies or contains in its interior. This space may particularly be hollow so as to be configured to receive something. Thus, the internal volume of the reaction vessel may refer to a hollow space within the reaction vessel which is configured to receive the electronic components of the reaction vessel.

The at least one sensor may be configured to measure the physical parameter associated with the at least one of the processing stations of the diagnostic analyzer when disposed at the at least one of the processing stations. Thus, the reaction vessel is handled like a normal sample vessel only without the transfer of any liquid. Thereby, the measured physical parameter is as much realistic as technically feasible.

The at least one sensor may be configured to measure the physical parameter associated with the at least one of the processing stations of the diagnostic analyzer during a test process of the diagnostic analyzer. Thus, the reaction vessel may be subject to a test program of the diagnostic analyzer allowing to reliably check the functionality of its components.

The processing unit may comprise a microcontroller. Thus, the processing unit may be rather small.

The power source may comprise a battery, a secondary battery, inductor and/or a capacitor. Thus, the power source may be designed as appropriate and depending on the spatial requirements of the reaction vessel. For example, the reaction vessel has an antenna and electronic components to receive the energy sent by an inductor via inductive coupling, capacitive coupling or radio waves. The energy is stored in one or more battery/batteries or capacitor(s). Suitable induction methods are selected from the group consisting of Qi, power over WiFi.

The memory may comprise a random access memory, particularly DRAM, SRAM, DDR RAM, or random access solid state memory, and/or a non-volatile memory, particularly a magnetic disk storage device, an optical disk storage device, a flash memory device. Thus, the memory may be selected from a plurality of memory types and may be adapted to the spatial requirements of the reaction vessel.

The interface may be configured to provide wired and/or wireless communication of the processing unit with the external electronic device. Thus, the communication may be realized as appropriate and depending on the respective application of the reaction vessel.

The processing unit is configured to output the measurement data by means of a wired protocol and/or a wireless protocol, particularly Bluetooth, Bluetooth Low Energy (BLE), Infrared, or WiFi. Thus, the output may be realized as appropriate and depending on the respective application of the reaction vessel.

The processing unit may be configured to output the measurement data by means of the interface. Thus, the measurement data may be output in a wired or wireless manner.

The interface may comprise at least one device selected from the group consisting of: an antenna, an optical device, a USB device, an Ethernet device. Thus, the interface may be selected as appropriate and depending on the spatial requirements of the reaction vessel.

The processing unit is configured to output the measurement data in real time or subsequent to a measurement of the physical parameter. Thus, the output may be carried out during a measurement or subsequent to a measurement.

The processing unit may be configured to output the measurement data when receiving a trigger signal from the external electronic device. Thus, the measurement data may be output when requested or on demand.

The diagnostic analyzer may comprise multiple receiving units for receiving a signal from the reaction vessel. If, e.g., BLE is used with multiple receiving units the position on the diagnostic analyzer can be tracked and correlated with the position the diagnostic analyzer determines the reaction vessel is at.

The reaction vessel may further comprise a RFID module configured to communicate with the diagnostic analyzer. Thus, it may be ensured that the diagnostic analyzer knows which functions the reaction vessel provides and which analyzer program may be carried out for checking the functionality of the diagnostic analyzer.

The reaction vessel may be liquid tight. Thus, any damage of the electronic components caused by liquid is prevented.

The internal volume may be 50 μl to 100 ml and typically 100 μl to 10 ml. Thus, the reaction vessel may be rather small.

The reaction vessel may further comprise a light receiver, particularly a camera device. With this design, positioning and/or orientation of the components of the diagnostic analyzer may be checked depending on the light detected by the light receiver.

Alternatively or in addition, the reaction vessel may comprise a light source configured to emit light. The light emitted from the light source by be detected by a light receiver comprised by the reaction vessel or by the components of the diagnostic analyzer. With this design, positioning and/or orientation of the components of the diagnostic analyzer may be checked depending on the light detected by the light receiver.

The external electronic device may be a computer. Thus, the processing unit may be programmed and/or the measurement data output may be further processed by the computer.

The sensor may be at least one sensor selected from the group consisting of: temperature sensor, orientation sensor, gyroscope, accelerometer, magnetometer, proximity sensor, ultrasonic sensor, pressure sensor, GPS sensor, humidity sensor, pH meter, ion concentration sensor. Thus, a plurality of sensor types may be used with the reaction vessel. The sensor may include multiple sensors of the same type at different positions within the reaction vessel. Thereby, a profile of the characteristics to be detected may be revealed. For example, multiple temperature sensors at different positions within the reaction vessel allow to detect a temperature gradient.

The reaction vessel may comprise a plurality of different sensors. Thus, a plurality of different physical parameters can be measured or detected.

The at least one sensor, the memory, the processing unit, the power source and the interface may be arranged as a system on a chip device. Thus, these components may be provided as a miniaturized or compact device.

According to a second aspect of the present disclosure, a method for checking a functionality of a diagnostic analyzer comprising a plurality of processing stations is disclosed, wherein the method comprises the following steps, typically as in the given order:
providing a reaction vessel according to any one of the embodiments of the first aspect,
measuring at least one physical parameter associated with at one of the processing stations by means of the sensor,
at least temporarily storing a measurement value indicating the physical parameter measured by the sensor in the memory,
outputting measurement data including the measurement value from the memory to an external electronic device, and
comparing the measurement data with target data.

The method may further include disposing the reaction vessel at the processing station.

The method may further include determining a proper functionality if comparing the measurement data with target data reveals a difference smaller than or equal to a predetermined threshold, and determining an improper functionality if comparing the measurement data with target data reveals a difference greater than the predetermined threshold.

The method may further include carrying out a test process of the diagnostic analyzer and measuring the physical parameter during the test process of the diagnostic analyzer.

The measurement data may be output by means of the interface.

The measurement data may be output in a wired or wireless manner.

The physical parameter may be at least one parameter selected from the group consisting of: position of the reaction vessel, orientation of the reaction vessel, acceleration acting on the reaction vessel, g-forces acting on the reaction vessel, vibration acting on the reaction vessel, tilt of the reaction vessel, rotation of the reaction vessel, magnetic field acting on the reaction vessel, proximity to an object outside of the reaction vessel, pressure on or within the reaction vessel, humidity within the reaction vessel, temperature within the reaction vessel, concentration of a fluid, particularly liquid, within the reaction vessel.

The method may further comprise detecting light emitted by a light source associated with a component of the diagnostic analyzer and/or reflected from a component of the diagnostic analyzer.

The method may further comprise adjusting the orientation and/or position of the component of the diagnostic analyzer based on the detected light.

According to a third aspect of the present disclosure, a reaction vessel for a diagnostic analyzer comprising a plurality of processing stations is disclosed, wherein the reaction vessel comprises:
at least one light receiver configured to detect light emitted and/or reflected from a component associated with at least one of the processing stations of the diagnostic analyzer,
a memory configured to at least temporarily store at least one measurement value indicating the detected light provided by the light receiver,
a processing unit configured to control the light receiver and to output measurement data including the measurement value from the memory,
an interface configured to provide communication of the processing unit with an external electronic device,
a power source configured to supply electric power to the light receiver, the processing unit and the memory,
wherein the reaction vessel defines an internal volume, wherein the light receiver, the processing unit, the memory and the interface are arranged within the internal volume.

The processing unit may be configured to determine an orientation and/or position of the component associated with at least one of the processing stations of the diagnostic analyzer based on the measurement value.

The orientation of the component may include a position of the component and/or an angle of the component with respect to a reference object and/or a proximity of the component relative to the reaction vessel.

The light may be laser light, light from a diode or infrared light.

The reaction vessel may further comprise at least one sensor configured to measure at least one physical parameter associated with at least one of the processing stations of the diagnostic analyzer, the memory may be configured to at least temporarily store at least one measurement value indicating the physical parameter provided by the sensor, and the processing unit may be configured to control the sensor and to output measurement data including the measurement value from the memory.

The processing unit may comprise a microcontroller. Thus, the processing unit may be rather small.

The power source may comprise a battery, a secondary battery, inductor and/or a capacitor. Thus, the power source may be designed as appropriate and depending on the spatial requirements of the reaction vessel.

The memory may comprise a random access memory, particularly DRAM, SRAM, DDR RAM, or random access solid state memory, and/or a non-volatile memory, particularly a magnetic disk storage device, an optical disk storage device, a flash memory device. Thus, the memory may be selected from a plurality of memory types and may be adapted to the spatial requirements of the reaction vessel.

The interface may be configured to provide wired and/or wireless communication of the processing unit with the external electronic device. Thus, the communication may be realized as appropriate and depending on the respective application of the reaction vessel.

The processing unit is configured to output the measurement data by means of a wired protocol and/or a wireless protocol, particularly Bluetooth, BLE or WiFi. Thus, the output may be realized as appropriate and depending on the respective application of the reaction vessel.

The processing unit may be configured to output the measurement data by means of the interface. Thus, the measurement data may be output in a wired or wireless manner.

The interface may comprise at least one device selected from the group consisting of: an antenna, an optical device, a USB device, an Ethernet device. Thus, the interface may be selected as appropriate and depending on the spatial requirements of the reaction vessel.

The processing unit is configured to output the measurement data in real time or subsequent to a measurement of the physical parameter. Thus, the output may be carried out during a measurement or subsequent to a measurement.

The processing unit may be configured to output the measurement data when receiving a trigger signal from the external electronic device. Thus, the measurement data may be output when requested or on demand.

The reaction vessel may further comprise a RFID module configured to communicate with the diagnostic analyzer. Thus, it may be ensured that the diagnostic analyzer knows which functions the reaction vessel provides and which analyzer program may be carried out for checking the functionality of the diagnostic analyzer.

The reaction vessel may be liquid tight. Thus, any damage of the electronic components caused by liquid is prevented.

The internal volume may be 50 μl to 100 ml and typically 100 μl to 10 ml. Thus, the reaction vessel may be rather small.

The light receiver may be a camera device. With this design, positioning and/or orientation of the components of the diagnostic analyzer may be checked depending on the light detected by the light receiver.

The external electronic device may be a computer. Thus, the processing unit may programmed and/or the measurement data output may be further processed by the computer.

The sensor may be at least one sensor selected from the group consisting of: temperature sensor, orientation sensor, gyroscope, accelerometer, magnetometer, proximity sensor, ultrasonic sensor, pressure sensor, GPS sensor, humidity sensor, pH meter, ion concentration sensor. Thus, a plurality of sensor types may be used with the reaction vessel.

The reaction vessel may comprise a plurality of different sensors. Thus, a plurality of different physical parameters can be measured or detected.

The light receiver, the memory, the processing unit, the power source and the interface may be arranged as a system on a chip device. Thus, these components may be provided as a miniaturized or compact device.

According to a fourth aspect of the present disclosure, a diagnostic analyzer is disclosed, wherein the diagnostic analyzer comprises a plurality of processing stations, an adjusting device and a reaction vessel according to the third aspect, wherein at least one component of at least one of the processing stations comprises a light source and/or a reflector configured to emit and/or reflect light, wherein the external electronic device is configured to communicate with the adjusting device of the diagnostic analyzer, wherein the adjusting device is configured to adjust an orientation and/or position of the component according to a target orientation based on measurement data output from the processing unit to the external electronic device.

The reflector may be any reflecting device such as a mirror, a reflecting coating or the like.

The external electronic device is configured to be connected to the adjusting device of the diagnostic analyzer or may be part of the diagnostic analyzer.

The external electronic device may be configured to calculate a deviation of an actual orientation of the component from the target orientation and to provide orientation correction data to the adjusting device, wherein the adjusting device is configured to adjust the actual orientation of the component to the target orientation based on the orientation correction data.

The light source may be a laser light source, a diode or an infrared light source.

If the light source is provided at the component, the reflector may be provided at the reaction vessel and the component may comprise a light receiver configured to detect the light reflected by the reflector. For example, the position of the reaction vessel may be determined by LIDAR and may be correlated with reference points.

According to a fifth aspect of the present disclosure, a method for determining an orientation a component associated with at least one of a plurality of processing stations of a diagnostic analyzer is disclosed, wherein the component comprises a light source and/or a reflector, wherein the method includes the following steps, typically as in the given order:
providing a reaction vessel according to any one of the embodiments of the third aspect,
detecting light emitted from the light source of the component and/or reflected from the reflector of the component associated with at one of the processing stations by means of the light receiver,
at least temporarily storing a measurement value indicating the detected light provided by the light receiver in the memory,
outputting measurement data including the measurement value from the memory to an external electronic device, and
determining an orientation of the component associated with at least one of the processing stations of the diagnostic analyzer based on the measurement value.

The method may further include adjusting an actual orientation of the component associated with at least one of the processing stations of the diagnostic analyzer to a target orientation based on the measurement value.

The orientation of the component may include a position of the component and/or an angle of the component with respect to a reference object.

The light may be laser light, light from a diode or infrared light.

Further disclosed and proposed herein is a computer program including computer-executable instructions for performing the method according to the present disclosure in one or more of the embodiments enclosed herein when the program is executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps as indicated above may be performed by using a computer or a computer network, typically by using a computer program.

Further disclosed and proposed herein is a computer program product having program code means, in order to perform the method according to the present disclosure in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the disclosure, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing and without excluding further possible embodiments, the following embodiments may be envisaged:

Embodiment 1: A reaction vessel for a diagnostic analyzer comprising a plurality of processing stations, comprising:
at least one sensor configured to measure at least one physical parameter associated with at least one of the processing stations of the diagnostic analyzer,
a memory configured to at least temporarily store at least one measurement value indicating the physical parameter provided by the sensor,
a processing unit configured to control the sensor and to output measurement data including the measurement value from the memory,
an interface configured to provide communication of the processing unit with an external electronic device,
a power source configured to supply electric power to the sensor, the processing unit and the memory,
wherein the reaction vessel defines an internal volume, wherein the sensor, the processing unit, the memory and the interface are arranged within the internal volume.

Embodiment 2: The reaction vessel according to the preceding embodiment, wherein the at least one sensor is configured to measure the physical parameter associated with the at least one of the processing stations of the diagnostic analyzer when disposed at the at least one of the processing stations.

Embodiment 3: The reaction vessel according to any one of the preceding embodiments, wherein the at least one sensor is configured to measure the physical parameter associated with the at least one of the processing stations of the diagnostic analyzer during a test process of the diagnostic analyzer.

Embodiment 4: The reaction vessel according to any one of the preceding embodiments, wherein the processing unit comprises a microcontroller.

Embodiment 5: The reaction vessel according to any one of the preceding embodiments, wherein the power source comprises a battery, a secondary battery, inductor and/or a capacitor.

Embodiment 6: The reaction vessel according to any one of the preceding embodiments, wherein the memory comprises a random access memory, particularly DRAM, SRAM, DDR RAM, or random access solid state memory, and/or a non-volatile memory, particularly a magnetic disk storage device, an optical disk storage device, a flash memory device.

Embodiment 7: The reaction vessel according to any one of the preceding embodiments, wherein the interface is configured to provide wired and/or wireless communication of the processing unit with the external electronic device.

Embodiment 8: The reaction vessel according to any one of the preceding embodiments, wherein the processing unit is configured to output the measurement data by means of a wired protocol and/or a wireless protocol, particularly Bluetooth, BLE or WiFi.

Embodiment 9: The reaction vessel according to any one of the preceding embodiments, wherein the processing unit is configured to output the measurement data by means of the interface.

Embodiment 10: The reaction vessel according to any one of the preceding embodiments, wherein the interface comprises at least one device selected from the group consisting of: an antenna, an optical device, a USB device, an Ethernet device.

Embodiment 11: The reaction vessel according to any one of the preceding embodiments, wherein the processing unit is configured to output the measurement data in real time or subsequent to a measurement of the physical parameter.

Embodiment 12: The reaction vessel according to any one of the preceding embodiments, wherein the processing unit is configured to output the measurement data when receiving a trigger signal from the external electronic device.

Embodiment 13: The reaction vessel according to any one of the preceding embodiments, further comprising a RFID module configured to communicate with the diagnostic analyzer.

Embodiment 14: The reaction vessel according to any one of the preceding embodiments, wherein the reaction vessel is liquid tight.

Embodiment 15: The reaction vessel according to any one of the preceding embodiments, wherein the internal volume is 50 μl to 100 ml and typically 100 μl to 10 ml.

Embodiment 16: The reaction vessel according to any one of the preceding embodiments, further comprising a light receiver, particularly a camera device.

Embodiment 17: The reaction vessel according to any one of the preceding embodiments, wherein the external electronic device is a computer.

Embodiment 18: The reaction vessel according to any one of the preceding embodiments, wherein the sensor is at least one sensor selected from the group consisting of: temperature sensor, orientation sensor, gyroscope, accelerometer, magnetometer, proximity sensor, ultrasonic sensor, pressure sensor, GPS sensor, humidity sensor, pH meter, ion concentration sensor.

Embodiment 19: The reaction vessel according to any one of the preceding embodiments, wherein the reaction vessel comprises a plurality of different sensors.

Embodiment 20: The reaction vessel according to any one of the preceding embodiments, wherein the at least one sensor, the memory, the processing unit, the power source and the interface are arranged as a system on a chip device.

Embodiment 21: A method for checking a functionality of a diagnostic analyzer comprising a plurality of processing stations, wherein the method comprises the following steps, typically as in the given order:
providing a reaction vessel according to any one of embodiments 1 to 20,
measuring at least one physical parameter associated with at one of the processing stations by means of the sensor,
at least temporarily storing a measurement value indicating the physical parameter measured by the sensor in the memory,
outputting measurement data including the measurement value from the memory to an external electronic device, and
comparing the measurement data with target data.

Embodiment 22: The method according to embodiment 21, further comprising disposing the reaction vessel at the processing station.

Embodiment 23: The method according to embodiment 21 or 22, further comprising determining a proper functionality if comparing the measurement data with target data reveals a difference smaller than or equal to a predetermined threshold, and determining an improper functionality if comparing the measurement data with target data reveals a difference greater than the predetermined threshold.

Embodiment 24: The method according to any one of embodiments 21 to 23, further comprising carrying out a test process of the diagnostic analyzer and measuring the physical parameter during the test process of the diagnostic analyzer.

Embodiment 25: The method according to any one of embodiments 21 to 24, wherein the measurement data are output by means of the interface.

Embodiment 26: The method according to any one of embodiments 21 to 25, wherein the measurement data are output in a wired or wireless manner.

Embodiment 27: The method according to any one of embodiments 21 to 26, wherein the measurement data are output when the processing unit receives a trigger signal from the external electronic device.

Embodiment 28: The method according to any one of embodiments 21 to 27, wherein the physical parameter may be at least one parameter selected from the group consisting of: position of the reaction vessel, orientation of the reaction vessel, acceleration acting on the reaction vessel, g-forces acting on the reaction vessel, vibration acting on the reaction vessel, tilt of the reaction vessel, rotation of the reaction vessel, magnetic field acting on the reaction vessel, proximity to an object outside of the reaction vessel, pressure on or within the reaction vessel, humidity within the reaction vessel, temperature within the reaction vessel, concentration of a fluid, particularly a liquid, within the reaction vessel.

Embodiment 29: The method according to any one of embodiments 21 to 28, further comprising detecting light emitted by a light source associated with a component of the diagnostic analyzer and/or reflected from a component of the diagnostic analyzer.

Embodiment 30: The method according to any one of embodiments 21 to 29, further comprising adjusting the orientation of the component of the diagnostic analyzer based on the detected light.

Embodiment 31: A reaction vessel for a diagnostic analyzer comprising a plurality of processing stations, wherein the reaction vessel comprises:
at least one light receiver configured to detect light emitted and/or reflected from a component associated with at least one of the processing stations of the diagnostic analyzer,
a memory configured to at least temporarily store at least one measurement value indicating the detected light provided by the light receiver,
a processing unit configured to control the light receiver and to output measurement data including the measurement value from the memory,
an interface configured to provide communication of the processing unit with an external electronic device,
a power source configured to supply electric power to the light receiver, the processing unit and the memory,
wherein the reaction vessel defines an internal volume, wherein the light receiver, the processing unit, the memory and the interface are arranged within the internal volume.

Embodiment 32: The reaction vessel according to embodiment 31, wherein the processing unit is configured to determine an orientation of the component associated with at least one of the processing stations of the diagnostic analyzer based on the measurement value.

Embodiment 33: The reaction vessel according to embodiment 31 or 32, wherein the orientation of the component includes a position of the component and/or an angle of the component with respect to a reference object.

Embodiment 34: The reaction vessel according to any one of embodiments 31 to 33, wherein the light is laser light, light from a diode or infrared light.

Embodiment 35: The reaction vessel according to any one of embodiments 31 to 34, further comprising at least one sensor configured to measure at least one physical parameter associated with at least one of the processing stations of the diagnostic analyzer, the memory may be configured to at least temporarily store at least one measurement value indicating the physical parameter provided by the sensor, and the processing unit may be configured to control the sensor and to output measurement data including the measurement value from the memory.

Embodiment 36: The reaction vessel according to any one of embodiments 31 to 35, wherein the processing unit comprises a microcontroller.

Embodiment 37: The reaction vessel according to any one of embodiments 31 to 36, wherein the power source comprises a battery, a secondary battery, inductor and/or a capacitor.

Embodiment 38: The reaction vessel according to any one of embodiments 31 to 37, wherein the memory comprises a random access memory, particularly DRAM, SRAM, DDR RAM, or random access solid state memory, and/or a non-volatile memory, particularly a magnetic disk storage device, an optical disk storage device, a flash memory device.

Embodiment 39: The reaction vessel according to any one of embodiments 31 to 38, wherein the interface is configured to provide wired and/or wireless communication of the processing unit with the external electronic device.

Embodiment 40: The reaction vessel according to any one of embodiments 31 to 39, wherein the processing unit is configured to output the measurement data by means of a wired protocol and/or a wireless protocol, particularly Bluetooth, BLE or WiFi.

Embodiment 41: The reaction vessel according to any one of embodiments 31 to 40, wherein the processing unit is configured to output the measurement data by means of the interface.

Embodiment 42: The reaction vessel according to any one of embodiments 31 to 41, wherein the interface comprises at least one device selected from the group consisting of: an antenna, an optical device, a USB device, an Ethernet device.

Embodiment 43: The reaction vessel according to any one of embodiments 31 to 42, wherein the processing unit is configured to output the measurement data in real time or subsequent to a measurement of the physical parameter. Thus, the output may be carried out during a measurement or subsequent to a measurement.

Embodiment 44: The reaction vessel according to any one of embodiments 31 to 43, wherein the processing unit is configured to output the measurement data when receiving a trigger signal from the external electronic device.

Embodiment 45: The reaction vessel according to any one of embodiments 31 to 44, further comprising a RFID module configured to communicate with the diagnostic analyzer.

Embodiment 46: The reaction vessel according to any one of embodiments 31 to 45, wherein the reaction vessel is liquid tight.

Embodiment 47: The reaction vessel according to any one of embodiments 31 to 46, wherein the internal volume is 50 μl to 100 ml and typically 100 μl to 10 ml.

Embodiment 48: The reaction vessel according to any one of embodiments 31 to 47, wherein the light receiver is a camera device.

Embodiment 49: The reaction vessel according to any one of embodiments 31 to 48, wherein the external electronic device is a computer.

Embodiment 50: The reaction vessel according to any one of embodiments 31 to 49, wherein the sensor is at least one sensor selected from the group consisting of: temperature sensor, orientation sensor, gyroscope, accelerometer, magnetometer, proximity sensor, ultrasonic sensor, pressure sensor, GPS sensor, humidity sensor, pH meter, ion concentration sensor.

Embodiment 51: The reaction vessel according to any one of embodiments 31 to 50, wherein the reaction vessel comprises a plurality of different sensors.

Embodiment 52: The reaction vessel according to any one of embodiments 31 to 51, wherein the light receiver, the memory, the processing unit, the power source and the interface are arranged as a system on a chip device.

Embodiment 53: A diagnostic analyzer comprising a plurality of processing stations, an adjusting device and a reaction vessel according to any one of embodiments 31 to 52, wherein at least one component of at least one of the processing stations comprises a light source configured to emit light and/or a reflector configured to reflect light, wherein the external electronic device is configured to communicate with the adjusting device of the diagnostic analyzer, wherein the adjusting device is configured to adjust an orientation of the component according to a target orientation based on measurement data output from the processing unit to the external electronic device.

Embodiment 54: The diagnostic analyzer according to embodiment 53, wherein the external electronic device is configured to be connected to the adjusting device of the diagnostic analyzer or may be part of the diagnostic analyzer.

Embodiment 55: The diagnostic analyzer according to embodiment 53 or 54, wherein the external electronic device is configured to calculate a deviation of an actual orientation of the component from the target orientation and to provide orientation correction data to the adjusting device, wherein the adjusting device is configured to adjust the actual orientation of the component to the target orientation based on the orientation correction data.

Embodiment 56: The diagnostic analyzer according to any one of embodiments 53 to 55, wherein the light source is a laser light source, a diode or an infrared light source.

Embodiment 57: A method for determining an orientation a component associated with at least one of a plurality of processing stations of a diagnostic analyzer, wherein the component comprises a light source and/or a reflector, wherein the method includes the following steps, typically as in the given order:
providing a reaction vessel according to any one of embodiments 31 to 52,
detecting light emitted from the light source and/or reflected from the reflector of the component associated with at one of the processing stations by means of the light receiver,
at least temporarily storing a measurement value indicating the detected light provided by the light receiver in the memory,
outputting measurement data including the measurement value from the memory to an external electronic device, and
determining an orientation of the component associated with at least one of the processing stations of the diagnostic analyzer based on the measurement value.

Embodiment 58: The method according to embodiment 57, further comprising adjusting an actual orientation of the component associated with at least one of the processing stations of the diagnostic analyzer to a target orientation based on the measurement value.

Embodiment 59: The method according to embodiment 57 or 58, wherein the orientation of the component includes a position of the component and/or an angle of the component with respect to a reference object.

Embodiment 60: The method according to any one of embodiments 57 to 59, wherein the light is laser light, light from a diode or infrared light.

In order that the embodiments of the present disclosure may be more readily understood, reference is made to the following examples, which are intended to illustrate the disclosure, but not limit the scope thereof.

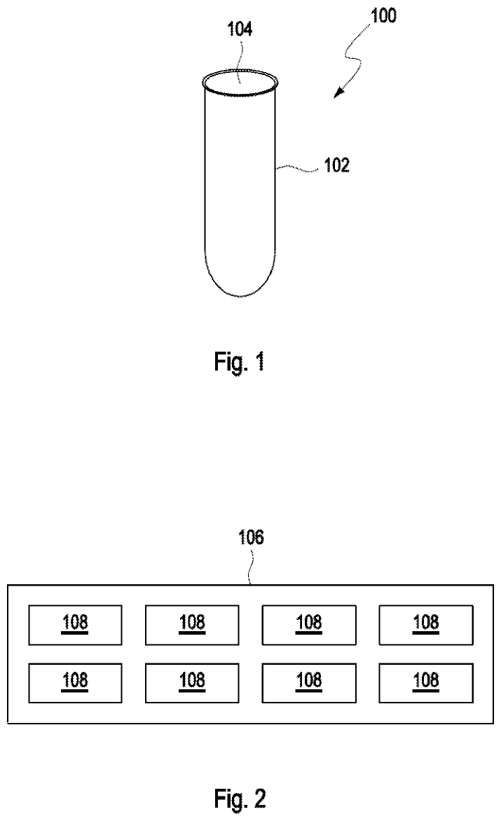

FIG. 1 shows a reaction vessel 100 according to a first embodiment of the present disclosure. The reaction vessel 100 has a shape similar or identical to a sample vessel. As such, the reaction vessel 100 may be made at least partially of a plastic material. The reaction vessel 100 comprises at least one vessel wall 102 defining an internal volume 104. The internal volume is 50 μl to 100 ml and typically 100 μl to 10 ml. For example, the internal volume 104 is 1.5 ml.

FIG. 2 shows a schematic illustration of a diagnostic analyzer 106. The reaction vessel 100 is configured to be used by the diagnostic analyzer 106. The diagnostic analyzer 106 comprises a plurality of processing stations 108. Some of the processing stations 108 may be different from one another whereas some of the processing stations 108 may be identical in order to increase the throughput of certain processing steps. The processing stations 108 include one or more stations selected from the group consisting of: centrifuge, mixer, pipettor, gripper, incubator, shaker, evaporator, vessel tray loader.

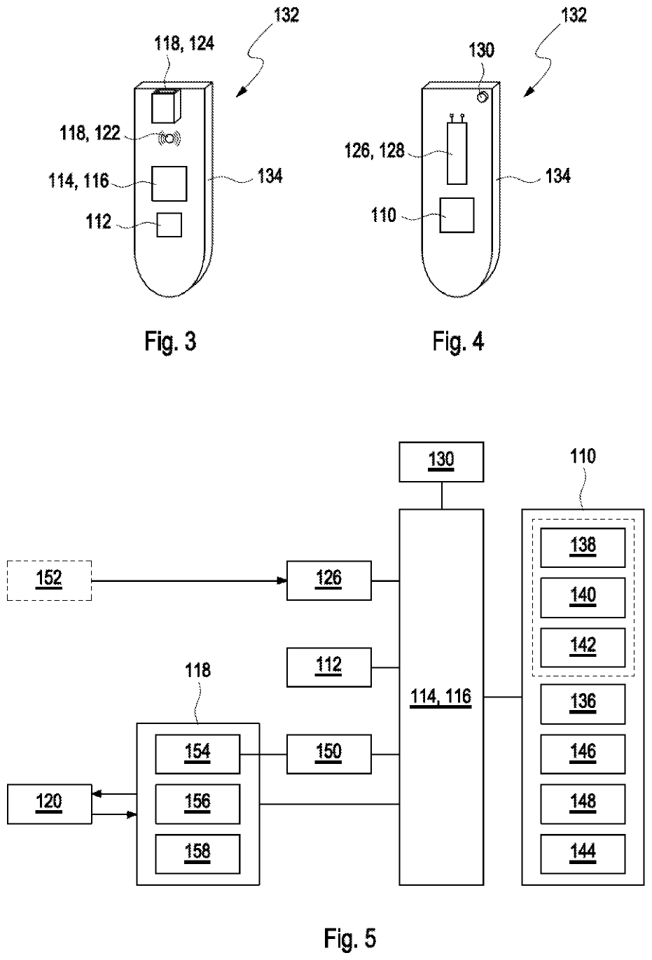

FIG. 3 shows a front view of electronic components of the reaction vessel 100. FIG. 4 shows a rear view of the electronic components of the reaction vessel 100. The reaction vessel 100 comprises at least one sensor 110. The sensor 110 is configured to measure at least one physical parameter associated with at least one of the processing stations 108 of the diagnostic analyzer 106. The sensor 110 is at least one sensor selected from the group consisting of: temperature sensor, orientation sensor, gyroscope, accelerometer, magnetometer, proximity sensor, ultrasonic sensor, pressure sensor, GPS sensor, humidity sensor, pH meter, ion concentration sensor. In the present embodiment, the reaction vessel 100 comprises a plurality of different sensors 110 as will be explained in further detail with respect to FIG. 5. The at least one sensor 110 is configured to measure the physical parameter associated with the at least one of the processing stations 108 of the diagnostic analyzer 106 when disposed at the at least one of the processing stations 108. Particularly, the at least one sensor 110 is configured to measure the physical parameter associated with the at least one of the processing stations 108 of the diagnostic analyzer 106 during a test process of the diagnostic analyzer 106.

The reaction vessel 100 further comprises a memory 112 configured to at least temporarily store at least one measurement value indicating the physical parameter provided by the sensor 110. The memory 112 comprises a random access memory, particularly DRAM, SRAM, DDR RAM, or random access solid state memory, and/or a non-volatile memory, particularly a magnetic disk storage device, an optical disk storage device, a flash memory device.

The reaction vessel 100 further comprises a processing unit 114 configured to control the sensor 110 and to output measurement data including the measurement value from the memory 112. The processing unit 114 comprises a microcontroller 116. The processing unit 114 is configured to output the measurement data by means of a wired protocol and/or a wireless protocol, particularly Bluetooth, BLE or WiFi.

The reaction vessel 100 further comprises an interface 118 configured to provide communication of the processing unit 114 with an external electronic device 120. The external electronic device 120 may be a computer. The interface 118 is configured to provide wired and/or wireless communication of the processing unit 114 with the external electronic device 120. The interface 118 comprises at least one device selected from the group consisting of: an antenna 122, an optical device, an USB device 124, an Ethernet device. In the present embodiment, the interface 118 comprises an antenna 122 and a USB device 124 such as micro USB device. The processing unit 114 is configured to output the measurement data by means of the interface 118. Particularly, the processing unit 114 is configured to output the measurement data in real time or subsequent to a measurement of the physical parameter. For example, the processing unit 114 is configured to output the measurement data when receiving a trigger signal from the external electronic device 120.

The reaction vessel 100 further comprises a power source 126 configured to supply electric power to the sensor 110, the processing unit 114 and the memory 112. Needless to say, the power source 126 may be configured to supply electric power to the interface 118 if necessary. The power source 126 comprises a battery, a secondary battery, inductor and/or a capacitor. In the present embodiment, the power source 126 comprises at least one battery 128.

The reaction vessel 100 further comprises an optional LED 130 such as an optical LED. The optical LED 130 is configured to display an operation state at least of the processing unit 114. Optionally, the reaction vessel 100 may further comprise a RFID module (not shown in detail) configured to communicate with the diagnostic analyzer 106. Optionally, the reaction vessel 100 may further comprise a light receiver, particularly a camera device such as a micro CCD camera.

The at least one sensor 110, the memory 112, the processing unit 114, the power source 126 and the interface 118 are arranged as a system on a chip device 132. In the present embodiment, the at least one sensor 110, the memory 112, the processing unit 114, the power source 126 and the interface 118 are mounted on a board 134 such as a printed circuit board. As shown in FIG. 3, merely as an example, the memory 112, the processing unit 114, the interface 118 and the antenna 122 are mounted to a front side of the board 134. As shown in FIG. 4, merely as an example, the sensors 110, the power source 126 and the optional LED 130 are mounted to a rear side of the board 134.

The electronic components of the reaction vessel 100 are miniaturized. As such, the sensor 110, the processing unit 114, the memory 112 and the interface 118 are arranged within the internal volume 104 defined by the reaction vessel 100. For example, the board 134 including the electronic components mounted thereon is arranged within the internal volume 104. Further, the reaction vessel 100 may be liquid tight. For example, the reaction vessel 100 may be closed by a cap, lid or the like (not shown in detail) preventing liquid from entering the internal volume 104.

FIG. 5 shows a block diagram of the electronic components of the reaction vessel 110. Particularly, FIG. 5 allows to identify the lines of communication of the electronic components of the reaction vessel 100 with one another and with external periphery.

As shown in FIG. 5, the processing unit 114 may be identified as a core of the electronic components. The processing unit 114 communicates with and controls the sensors 110. In the present embodiment, the reaction vessel 100 comprises a plurality of different sensors 110. For example, the reaction vessel 100 comprises a temperature sensor 136, a gyroscope 138, an accelerometer 140, a magnetometer 142, proximity sensor 144, a pressure sensor 146, and a humidity sensor 148. The reaction vessel 100 may further include a pH meter and/or an ion concentration sensor (not shown in detail). The gyroscope 138, the accelerometer 140, the magnetometer 142 may be integrated into one single sensor such as a 9-DOF sensor, e.g., BN0055 available from Bosch Sensortec GmbH, Germany.

Further, the processing unit 114 communicates with or controls each of the optional optical LED 130, the power source 126, the memory 112, the interface 118. Optionally, a clock source 150 may be provided between the processing unit 114 and the at least one interface 118. The clock source 150 may be synchronized externally. The power source 126 may be charged from an external power source 152. The interface 118 may include more than one interface devices such as a Bluetooth Low Energy (BLE) 154, a physical connection 156 such as a cable and/or the USB device 124 and an optical interface device 158 such as a Thunderbolt device. As shown in FIG. 5, the processing unit 114 communicates with the external electronic device 120 by the interface 118.

Hereinafter, an example for an application of the reaction vessel 100 will be described. The reaction vessel 100 may be used in order to check a functionality of the diagnostic analyzer 106. The reaction vessel 100 is provided. Particularly, the reaction vessel 100 and its electronic components, respectively, are switched or powered on. For example, the switching on may be triggered by a command from the external electronic device 120. Further, the reaction vessel 100 is disposed at that processing station 108 of which at least one physical parameter is to be measured. Subsequently, a test process of the diagnostic analyzer 106 is carried out. During the test process of the diagnostic analyzer 106 the at least one physical parameter is measured by the at least one sensor 110. For example, if the reaction vessel 100 is disposed at an incubator, a temperature within the reaction vessel 100 during a test incubation process may be measured by the temperature sensor 136 which substantially corresponds to the temperature within the incubator. The temperature sensor 136 may monitor a temperature, temperature rates, heat transfer through vessel wall 102, a temperature distribution if multiple measuring points within reaction vessel 100 are realized. As another example, if the reaction vessel 100 is disposed at a mixer, centrifuge or shaker, g-forces and acceleration during sample mixing and movements may be measured. The accelerometer 140 detects acceleration, vibration and tilt acting on the reaction vessel 100 to determine movement and exact orientation along the three room axes. The gyroscope 138 can measure additionally rotation. The magnetometer 142 may detect magnetic fields during, e.g., magnetic bead sample preparation. The proximity sensor 144 may measure proximity to outside objects by means of an IR LED and IR detector. The pressure sensor 146 may measure the pressure in the reaction vessel 100, e.g., at a vacuum evaporation station of the diagnostic analyzer 106. Basically, the physical parameter may be at least one parameter selected from the group consisting of: position of the reaction vessel, orientation of the reaction vessel, acceleration acting the reaction vessel, g-forces acting on the reaction vessel, vibration acting on the reaction vessel, tilt of the reaction vessel, rotation of the reaction vessel, magnetic field acting on the reaction vessel, proximity to an object outside of the reaction vessel, pressure on or within the reaction vessel, humidity within the reaction vessel, temperature within the reaction vessel, concentration of a fluid, particularly a liquid, within the reaction vessel.

A measurement value indicating the physical parameter measured by the sensor 110 can be at least temporarily stored in the memory 112. After the test process, measurement data including the measurement value are output from the memory 112 to the external electronic device 120. The output may be triggered by a corresponding command from the external electronic device 120. Alternatively, the measurement data may be output in real time. The measurement data may be output by means of the interface 118. Particularly, the measurement data may be output in a wired or wireless manner. Subsequently, the measurement data are compared with target data. The comparing step may be carried out by the external electronic device 120. A proper functionality is determined if comparing the measurement data with target data reveals a difference smaller than or equal to a predetermined threshold. On the other hand, an improper functionality is determined if comparing the measurement data with target data reveals a difference greater than the predetermined threshold. For example, if measurement data including a measurement value for a temperature measured by the temperature sensor 136 of the reaction vessel 100 during presence in an incubator reveal a difference from a target temperature value being smaller than a predetermined threshold, it can be concluded that a deviation of the actual temperature from a target temperature is smaller than a predetermined threshold. Thus, the actual temperature is within an acceptable range for the temperature meaning that the incubator properly works. Needless to say, the test process may be repeated a predetermined time and an average value of the measurement data may be calculated. In this case, an improper functionality is determined if comparing the average of the measurement data with the target data reveals a difference greater than the predetermined threshold.

If the reaction vessel 100 comprises the optional light receiver, the method may further include detecting light emitted by a light source associated with a component of the diagnostic analyzer 106. Thus, the method may further comprise adjusting the orientation and/or position of the component of the diagnostic analyzer 106 based on the detected light. For example, the light receiver is a camera and may be used in order to detect light emitted from a light source mounted to a pipettor so as to check whether the pipettor moves correctly to a target position. The check of the position of the pipettor may be based on the amount, angle and/or position and/or wavelength of light incident on the light receiver. If a deviation of the pipettor from its target position is detected, the pipettor may be adjusted in its position so as to allow a proper pipetting process. Alternatively or in addition, the light receiver may detect light reflected from a component of the diagnostic analyzer 106. In this case, the reaction vessel may further comprise a light source.

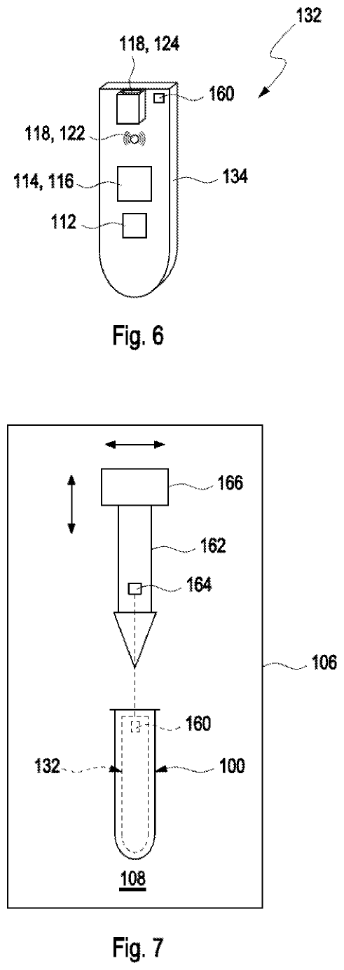

FIG. 6 shows a front view of electronic components of a reaction vessel 100 according to a second embodiment of the present disclosure. Hereinafter, only the difference from the reaction vessel 100 according to the first embodiment are described and like constructional members are indicated by like reference numerals. Rather than the at least one sensor 110, the reaction vessel 100 of the second embodiment comprises a light receiver 160. The light receiver 160 may particularly be a camera device such as a micro CCD camera. The reaction vessel 100 is configured to be used with a diagnostic analyzer 106 comprising a plurality of processing stations 108.

FIG. 7 shows a schematic illustration of another diagnostic analyzer 106. Hereinafter, only the difference from the analyzer 106 according to the first embodiment are described and like constructional members are indicated by like reference numerals. The diagnostic analyzer 106 not only comprises the plurality of processing stations 108 but also at least one component 162 associated with at least one of the processing stations 108. For example, the component 162 may be a pipettor associated with a pipetting station.

The light receiver 160 is configured to detect light emitted and/or reflected from the component 162 associated with at least one of the processing stations 108 of the diagnostic analyzer 162. The light may be laser light, light from a diode or infrared light. For this purpose, a light source 164 such as a laser light source, a diode or infrared light source may be mounted or connected or integrated with the pipettor. The memory 112 is configured to at least temporarily store at least one measurement value indicating the detected light provided by the light receiver 160. The processing unit 114 is configured to control the light receiver 160 and to output measurement data including the measurement value from the memory 112. Particularly, the processing unit 114 is configured to determine an orientation and/or position of the component 162 associated with at least one of the processing stations 108 of the diagnostic analyzer 106 based on the measurement value. The orientation and/or position of the component 162 includes a position of the component 162 and/or an angle of the component with respect to a reference object such as a target pipetting path. For example, the light receiver 160 is used in order to detect light emitted from the light source 164 mounted to the pipettor so as to check whether the pipettor moves correctly to a target position. The check of the position of the pipettor may be based on the amount, angle, wavelength and/or position of light incident on the light receiver 160. If a deviation of the pipettor from its target position is detected, the pipettor may be adjusted in its position in all directions of the three dimensional space so as to allow a proper pipetting process. Alternatively or in addition to the light receiver, the reaction vessel may comprise an ultrasonic detector configured to detect and/or emit ultrasound in order to determine an orientation and/or position of the component 162 associated with at least one of the processing stations 108 of the diagnostic analyzer 106.

For this purpose, the diagnostic analyzer 106 comprises an adjusting device 166. The adjusting device 166 is configured to adjust an orientation of the component 162 according to a target orientation based on measurement data output from the processing unit 114 to the external electronic device 120. The adjusting device may be a xyz-stage or the like configured to move the pipettor along all three axis of a room. The external electronic device 120 is configured to be connected to the adjusting device 166 or may be part of the diagnostic analyzer 106. Particularly, the external electronic device 120 is configured to calculate a deviation of an actual orientation of the component 162 from the target orientation and to provide orientation correction data to the adjusting device 166. The adjusting device 166 is configured to adjust the actual orientation of the component 162 to the target orientation based on the orientation correction data.

Hereinafter, an example for an application of the reaction vessel 100 will be described. The reaction vessel 100 may be used in order to determine an orientation the component 162 associated with at least one of the plurality of processing stations 108 of the diagnostic analyzer 106. The reaction vessel 100 of the second embodiment is provided. The electronic components are switched or powered on such as by means of a command from the external electronic device 120. The reaction vessel 100 is disposed at the processing station 108 of which the orientation is to be determined. The light source 164 of the component 162 emits light towards the light receiver 160. The light emitted from the light source 164 of the component 162 associated with at one of the processing stations 108 is detected by means of the light receiver 160. A measurement value indicating the detected light provided by the light receiver 160 is at least temporarily stored in the memory 112. Measurement data including the measurement value are output from the memory 112 to the external electronic device 120. The output may be triggered by a corresponding command from the external electronic device 120. Alternatively, the measurement data may be output in real time. Subsequently, an orientation of the component 162 associated with at least one of the processing stations 108 of the diagnostic analyzer 106 is determined based on the measurement value. The orientation of the component 162 includes a position of the component 162 and/or an angle of the component 162 with respect to a reference object. For example, the light receiver 160 detects an amount, a position and/or an angle and/or a wavelength of the light incident thereon. The external electronic device 120 may calculate the orientation of the component 162 based on the measurement data including the measurement value which corresponds to the amount, a position and/or an angle and/or a wavelength of the light incident on the light receiver 160. Further, an actual orientation of the component 162 associated with at least one of the processing stations 108 of the diagnostic analyzer 106 is adjusted to a target orientation based on the measurement value. The adjusting of the orientation of the component 162 to its target orientation is carried out by the adjusting device 166 communicating with the external electronic device 120. Needless to say, the reaction vessel 100 may be disposed at more than one processing station. For example, the reaction vessel 100 may follow all processing stations a normal sample tube passes, i.e., the reaction vessel 100 starts with being disposed in the vessel tray and is returned therein at the end.

The control of the orientation of the component can be performed using a software running on the external electronic device 120 with feedback loops. A more specific task in adjusting vessel handling devices is the adjustment of the height of the component, i.e., along a z-axis. Here the usage of the physical phenomena of induction can help. Using different induction coils integrated into the reaction vessel 100, the height of the component can be measured and consequently be used for adjustment. A reaction vessel 100 made of metal in combination with using already in place technology such as liquid level detection corresponding to conductivity of the pipettors can be used to improve adjustment procedures. Two scenarios are feasible. A small pin on top of the metal reaction vessel 100 can be a precise contact point for adjustment and inform the field service engineer either by a) sound or b) visual information such as a LED. Adjustment can this way be semi-automated, wherein the field service engineer sees and/or hears with increased frequency when he arrives at the aimed position such as similar to a car parking system. In addition or alternatively, ultrasonic detection for height measurements similar to parking help for cars can be used. Alternatively, a fix point for LIDAR can be applied.

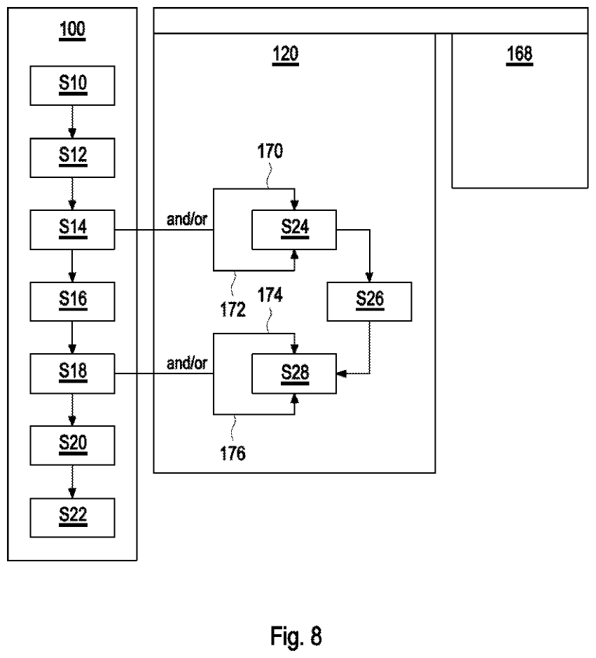

FIG. 8 shows a flowchart of an example for a method for detecting physical parameters at the diagnostic analyzer 106 by means of the reaction vessel 100. This method can particularly be carried out by using the reaction vessel 100 according to the first embodiment. Particularly, FIG. 8 shows the reaction vessel 100 disposed at the diagnostic analyzer 106. Further, FIG. 8 shows an external electronic device 120. The external electronic device 120 comprises a wireless network such as BLE, WiFi, RFID reader and the like. The external electronic device 120 further comprises a microprocessor including a clock and simple logics. The external electronic device 120 further comprises a data storage having a fast enough writing speed. The external electronic device 120 further comprises an optional interface to the diagnostic analyzer for trigger reception and commands. The external electronic device 120 further comprises an optional interface to an external data processing unit for live transmission of signals, dashboards, warnings and the like. The external electronic device 120 may communicate with an external device 168 for data viewing and treatment which may be connected to an external microcontroller. The external device 168 comprises visualization means such as monitor, display, and the like. The external device 168 allows a live comparison to defined thresholds for warning, live representation of the diagnostic analyzer status and run status. It is explicitly stated that the external electronic device 120 and the external device 168 could be provided in one solution, i.e., integrated into one device, e.g., as a tablet with compatible Bluetooth interface and protocols).

The method starts with one or more reaction vessel 100 disposed at the diagnostic analyzer 106 which has programmable run parameters. In step S10, the at least one reaction vessel 100 is put on or gets on a rack carrying the same. In a subsequent step S12, the operator starts a service run or test process. In a subsequent step S14, the diagnostic analyzer 106 starts the run. In a subsequent step S16, a movement of the reaction vessel 100 is performed through one or more processing stations 108 and the positions of the reaction vessel 100 from the perspective of the diagnostic analyzer 106 is flagged with time stamps. During the movement, the reaction vessel 100 obtains the physical measurement data by means of its sensors 110 such as g-forces, pressure, temperature and the like as described above. In a subsequent step S18, the diagnostic analyzer 106 terminates the run. In a subsequent step S20, the operator terminates the service run or test process. In a subsequent step S22, the operator removes the at least one reaction vessel 100 from the diagnostic analyzer 106.

As is further shown in FIG. 8, following step S14 in which the diagnostic analyzer 106 starts, in step S24 logging of measurement data from the sensor 110 of the reaction vessel 100 starts which is initiated by a first software trigger 170 and/or a first sensor trigger 172 such as a movement of the reaction vessel 100. Subsequently, the method proceeds to step S26 in which a transmission of the logged measurement data from the sensors 110 together with a timestamp is carried out with a frequency of at least 1 Hz. In subsequent step S28, the logging of measurement data from the sensor 110 of the reaction vessel 100 is terminated. As is further shown in FIG. 8, following step S18 in which the diagnostic analyzer 106 terminates the run, the method also proceeds to step S28 in which the logging of measurement data from the sensor 110 of the reaction vessel 100 is terminated, which is initiated by a second software trigger 174 and/or a second sensor trigger 176 such as a sensor 110 without a change of its signal, e.g., no movement of the reaction vessel 100.

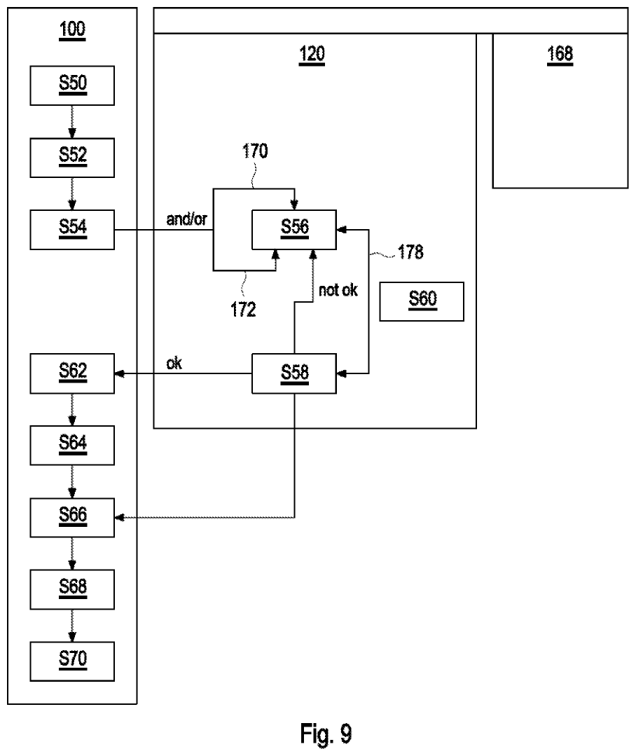

FIG. 9 shows a flowchart of an example for determining an orientation of a component of the diagnostic analyzer by means of the reaction vessel. This method can particularly be carried out by using the reaction vessel 100 according to the second embodiment. Particularly, FIG. 9 shows the reaction vessel 100 disposed at the diagnostic analyzer 106. Hereinafter, only the differences from the method shown in FIG. 8 will be explained and like constructional features are indicated by like reference numerals. Particularly, the construction of the external electronic device 120 and the external device 168 is identical to the one shown in FIG. 8.

The method starts with one or more reaction vessel 100 disposed at the diagnostic analyzer 106 which has programmable run parameters. In step S50, the at least one reaction vessel 100 is put on or gets on a rack carrying the same. In a subsequent step S52, the operator starts a service run or test process. In a subsequent step S54, the diagnostic analyzer 106 starts an adjustment run with the reaction vessel 100 being on a first adjustment position n. As is further shown in FIG. 9, following step S54 in which the diagnostic analyzer 106 starts the adjustment run, in step S56 logging of measurement data from the sensor 110 of the reaction vessel 100 starts which is initiated by a first software trigger 170 and/or a first sensor trigger 172 such as a movement of the reaction vessel 100. As is further shown in FIG. 9, there is a feedback loop 178 between step S56 and a step S58 in which the orientation such as a position of a component of the diagnostic analyzer 106 such as a pipettor is checked against a reference point in a database of the diagnostic analyzer 106. During the feedback loop, in parallel step S60 a transmission of the logged measurement data from the sensors 110 together with a timestamp is carried out with a frequency of at least 1 Hz and a stepwise correction of the orientation or position of the component of the diagnostic analyzer 106 is carried out. If it is determined that the position of the component of the diagnostic analyzer 106 does not match with the reference point, i.e., there is a deviation of the actual position of the component from the target position thereof, the method returns from step S58 to step S56 and the logging of measurement data from the sensor 110 of the reaction vessel 100 continues. If in step S58 it is determined that the position of the component of the diagnostic analyzer 106 matches with the reference point, i.e., there is no deviation of the actual position of the component from the target position thereof, the method proceeds to step S62 in which the diagnostic analyzer 106 starts an adjustment run with the reaction vessel 100 being on a second adjustment position n+1. Subsequently, steps S56 to S60 are repeated as described before. The, the method proceeds to step S64 in which the diagnostic analyzer 106 starts an adjustment run with the reaction vessel 100 being on a further adjustment position n+x. Subsequently, steps S56 to S60 are repeated as described before. If all adjustment runs have been completed, the method proceeds to step S66 in which the diagnostic analyzer 106 terminates the run. In a subsequent step S68, the operator terminates the service run or test process. In a subsequent step S70, the operator removes the at least one reaction vessel 100 from the diagnostic analyzer 106. As is further shown in FIG. 9, if the service run includes a position check of only one adjustment position, the method may proceed from step S58 to step S68.

### LIST OF REFERENCE NUMBERS

100 reaction vessel
102 vessel wall
104 internal volume
106 diagnostic analyzer
108 processing station
110 sensor
112 memory
114 processing unit
116 microcontroller
118 interface
120 external electronic device
122 antenna
124 USB device
126 power source
128 battery
130 LED
132 system on a chip device
134 board
136 temperature sensor
138 gyroscope
140 accelerometer
142 magnetometer
144 proximity sensor
146 pressure sensor
148 humidity sensor
150 clock source
152 external power source
154 Bluetooth Low Energy (BLE)
156 physical connection
158 optical interface device
160 light receiver
162 component
164 light source
166 adjusting device
168 external device
170 first software trigger
172 first sensor trigger
174 second software trigger
176 second sensor trigger
178 feedback loop
S10 reaction vessel is put on or gets on a rack
S12 operator starts a service run or test process
S14 diagnostic analyzer starts run
S16 movement of reaction vessel is performed and the positions of the reaction vessel from the perspective of diagnostic analyzer is flagged with time stamps
S18 diagnostic analyzer terminates run
S20 operator terminates service run or test process
S22 operator removes reaction vessel
S24 logging of measurement data from the sensor of the reaction vessel starts
S26 transmission of logged measurement data from the sensors together with timestamp is carried out
S28 logging of measurement data from the sensor of the reaction vessel is terminated
S50 reaction vessel is put on or gets on a rack
S52 operator starts a service run or test process
S54 diagnostic analyzer starts adjustment run with the reaction vessel on first adjustment position n
S56 logging of measurement data from the sensor of the reaction vessel starts
S58 orientation of a component of the diagnostic analyzer is checked against a reference point in a database of the diagnostic analyzer
S60 transmission of the logged measurement data from the sensors together with a timestamp is carried out and a stepwise correction of the orientation of the component of the diagnostic analyzer is carried out
S62 diagnostic analyzer starts adjustment run with the reaction vessel on a second adjustment position n+1
S64 diagnostic analyzer starts adjustment run with the reaction vessel on a further adjustment position n+x
S66 diagnostic analyzer terminates run
S68 operator terminates service run or test process
S70 operator removes reaction vessel

What is claimed is:

1. A reaction vessel for a diagnostic analyzer comprising a plurality of processing stations, comprising:
at least one sensor configured to measure at least one physical parameter associated with at least one of the processing stations of the diagnostic analyzer when disposed at the at least one of the processing stations,
a memory configured to at least temporarily store at least one measurement value indicating the physical parameter provided by the sensor,
a processing unit configured to control the sensor and to output measurement data including the measurement value from the memory,
an interface configured to provide communication of the processing unit with an external electronic device,
a power source configured to supply electric power to the sensor, the processing unit and the memory,
wherein the reaction vessel defines an internal volume, wherein the sensor, the processing unit, the memory and the interface are arranged within the internal volume.

2. The reaction vessel according to claim 1, wherein the at least one sensor is configured to measure the physical parameter associated with the at least one of the processing stations of the diagnostic analyzer during a test process of the diagnostic analyzer.

3. The reaction vessel according to claim 1, wherein the processing unit comprises a microcontroller.

4. The reaction vessel according to claim 1, wherein the power source comprises a battery, a secondary battery, inductor and/or a capacitor.

5. The reaction vessel according to claim 1, wherein the memory comprises a random access memory, a random access solid state memory, and/or a non-volatile memory.

6. The reaction vessel according to claim 5, wherein the random access memory is selected from DRAM, SRAM and/or DDR RAM.

7. The reaction vessel according to claim 5, wherein the non-volatile memory is selected from a magnetic disk storage device, an optical disk storage device, and/or a flash memory device.

8. The reaction vessel according to claim 1, wherein the interface is configured to provide wired and/or wireless communication of the processing unit with the external electronic device.

9. The reaction vessel according to claim 1, wherein the processing unit is configured to output the measurement data by a wired protocol and/or a wireless protocol.

10. The reaction vessel according to claim 9, wherein the wireless protocol is selected from Bluetooth, BLE or WiFi.

11. The reaction vessel according to claim 1, wherein the processing unit is configured to output the measurement data by means of the interface.

12. The reaction vessel according to claim 1, wherein the processing unit is configured to output the measurement data when receiving a trigger signal from the external electronic device.

13. The reaction vessel according to claim 1, wherein the internal volume is 50 μl to 100 ml.

14. The reaction vessel according to claim 1, wherein the internal volume is 100 μl to 10 ml.

15. The reaction vessel according to claim 1, further comprising a light receiver.

16. The reaction vessel according to claim 15, wherein the light receiver is a camera device.

17. The reaction vessel according to claim 1, wherein the external electronic device is a computer.

18. The reaction vessel according to claim 1, wherein the sensor is at least one sensor selected from the group consisting of: a temperature sensor, an orientation sensor, a gyroscope, an accelerometer, a magnetometer, a proximity sensor, an ultrasonic sensor, a pressure sensor, a GPS sensor, a humidity sensor, a pH meter, and an ion concentration sensor.

19. The reaction vessel according to claim 1, wherein the reaction vessel comprises a plurality of different sensors.

20. The reaction vessel according to claim 1, wherein the at least one sensor, the memory, the processing unit, the power source and the interface are arranged as a system on a chip device.
